(19) United States
(12) Patent Application Publication
(10) Pub. No.: US 2025/0347379 A1
(43) Pub. Date: Nov. 13, 2025

(54) INTRUSIVE DETECTOR FOR PASSAGE OF A MECHANICAL PIG OR INSPECTION DEVICE INSIDE A PIPELINE

(71) Applicant: INLINE SERVICE, LLC, TOMBALL, TX (US)

(72) Inventor: JUSTIN SCRUGGS, HOUSTON, TX (US)

(73) Assignee: INLINE SERVICE, LLC, TOMBALL, TX (US)

(21) Appl. No.: 19/173,101

(22) Filed: Apr. 8, 2025

Related U.S. Application Data
(60) Provisional application No. 63/646,084, filed on May 13, 2024.

(51) Int. Cl. F16L 55/48; F16L 101/30

(52) U.S. Cl. CPC F16L 55/48; F16L 2101/30

(57) ABSTRACT

A device for indicating the passage of a mechanical pig beyond a predetermined location in a pipeline comprising an intrusive pig detector connected to a pipeline and communicating with the interior of the pipeline through an opening at the location. A trigger-plunger subassembly mounted in the pig detector and adapted to project into the interior of the pipeline through the opening and having a central rare earth magnet. A collar housing comprising magnetically opposing rare earth dogs. The magnetically opposing rare earth dogs are configured for movement toward and away from the central axis of the housing upon passage of the central rare earth magnet within the plunger subassembly having an opposite polarity to the magnetically opposing rare earth dogs, urging the dogs towards the central axis, releasing a stop nut, and allowing an indicator cover to move vertically to provide an indication that a pig has passed.

### CROSS-REFERENCE

This application claims the benefit of U.S. Provisional Application No. 63/646,084, filed May 13, 2024, which application is incorporated herein by reference.

### BACKGROUND

The present disclosure is directed to devices for determining the position of a pipeline pig or inspection device in a pipeline. More particularly, the present invention relates to a type of pig signaler, an apparatus for signaling the passage of a pipeline pig or inspection device beyond a predetermined point or points in a pipeline.

Existing art utilizes a spring to hold a triggering mechanism downward when subjected to the internal pressure of the pipeline when installed The force of the spring is directly dictated by the pressure in the pipeline. Thus, a range of springs are used depending on the anticipated pressure range of the pipeline. Further, existing art utilizes mechanical dog latches or catch fingers which are pivotal towards and away from the central axis of the housing and which are provided with catches. A trigger connects with an actuator which is positioned to bear against the sides of the catch fingers to cause them to pivot outwardly away from each other when the actuator moves up vertically. The catch fingers are provided with a garter spring to urge them radially inwardly towards the central axis. When a pig or inspection device moves in the pipeline past the trigger and actuates the trigger, the actuator will bear against the fingers and separate them radially against the action of the garter spring to release the lock pin and allow the indicator to move upwardly within the indicator housing so as to provide a visual indication that a pig or inspection device has passed

A problem with the existing art is that the pipe pressure variances require trial and error to determine proper spring sizing and mechanical dog latches or catch fingers are prone to wear and failure.

### SUMMARY

Provided herein is a device for indicating the passage of a mechanical pig or inspection device beyond a predetermined location in a pipeline comprising an intrusive detector for connecting to a pipeline and communicating with the interior of the pipeline through an opening at said location; a trigger-plunger subassembly slidably mounted in the detector and adapted to project downwardly into the interior of the pipeline through said opening having a central thru-port pressure canal and equalizing ports to neutralize the forces acting on the trigger-plunger subassembly due to internal pipeline pressure; a pipe nipple which can be connected to and protrude from the outside of a pipe in any conventional manner; a collar housing releasably connectable to the protruding pipe nipple; a stop nut slidably affixed to the collar housing; a cap affixed to the collar housing configured to establish a maximum limit travel of the stop nut; an indicator cover removably affixed to the stop nut configured to slide over the cap; a first compression spring positioned between the indicator cover and the cap, a second compression spring configured to push the trigger-plunger subassembly into the interior of the pipeline through said opening, a plurality of rare earth magnetically opposed dog magnets slidably positioned within an equivalent plurality of spaces provided in the collar housing, wherein said plurality of rare earth magnetically opposed dog magnets remain positioned apart from one another between the major diameter of the collar housing and the inside diameter of the indicator cover to prevent the stop nut and indicator cover from moving superiorly due to the force applied by the first compression spring.

In some embodiments, the trigger-plunger subassembly, further comprises a plunger comprising a trigger portion that penetrates the pipeline and a plunger rod portion that penetrates a hollow shaft in the collar housing; a central rare earth magnet with a hole therethrough; and the second compression spring positioned between the proximal end of the trigger portion and a shoulder at the base of the hollow shaft in the collar housing.

In some embodiments, the plurality of rare earth magnetically opposed dog magnets comprise Neodymium (Nd—Fe—B) or Samarium Cobalt (SmCo).

In some embodiments, the central rare earth magnet comprises Neodymium (Nd—Fe—B) or Samarium Cobalt (SmCo).

In some embodiments of the intrusive detector, the hollow shaft in the collar housing comprises a longitudinal geometric profile that is cylindrical. In other embodiments, the hollow shaft in the collar housing may have other longitudinal geometric profiles such as triangular, square, oval-shaped, “x” or cross-shaped, pentagonal, hexagonal, octagonal, etc., or alternatively may comprise a longitudinal profile that corresponds with having a number of sides equal in number to the number of rare earth magnetically opposed dog magnets slidably positioned within spaces provided in the collar housing

In some embodiments of the intrusive detector, the central rare earth magnet has a longitudinal geometric profile that is cylindrical. In other embodiments, the central rare earth magnet may have other longitudinal geometric profiles such as triangular, square, oval-shaped, “x” or cross-shaped, pentagonal, hexagonal, octagonal, etc., or alternatively may comprise a longitudinal profile that corresponds with having a number of sides equal in number to the number of rare earth magnetically opposed dog magnets slidably positioned within spaces provided in the collar housing.

In some embodiments of the intrusive detector, the plurality of rare earth magnetically opposed dog magnets comprise 2 dog magnets, or 3 dog magnets, or 4 dog magnets, or 5 dog magnets, or 6 dog magnets, or 7 dog magnets, or 8 dog magnets, or more than 8 dog magnets.

In some embodiments, the intrusive detector further comprises a debris wiper ring between the plunger portion and the nipple.

In some embodiments of the intrusive pig detector, the plunger sub-assembly central thru-port pressure canal in the trigger portion of the plunger connects to at least one pressure equalization port in the proximal plunger rod portion.

In some embodiments, the nipple and collar housing further comprise metal-to-metal sealing tapered threads.

In some embodiments of the intrusive pig detector, the plurality of rare earth magnetically opposed dog magnets prevent the stop nut from sliding proximally until a mechanical pig or cleaning device activates the plunger subassembly, pushing the trigger portion, the plunger rod portion and the central rare earth magnet proximally against the force of the second compression spring up to the location of the plurality of rare earth magnetically opposed dog magnets, attracting said opposed dog magnets, causing them to slidably retract internally within the collar housing, away from the major diameter of the collar housing and the inside diameter of the indicator cover, towards the central rare earth magnet positioned along a central axis of the intrusive pig detector.

In some embodiments of the intrusive detector, the first compression spring forces the stop nut and indicator cover to slidably move proximally until engaging the cap to provide a visual indication that a mechanical pig or inspection device has passed said location.

In some embodiments of the intrusive detector, the second compression spring is configured to push the trigger-plunger subassembly distally, back into the pipeline once the mechanical pig or cleaning device has completely passed the location.

In some embodiments, the trigger-plunger subassembly further comprises a non-magnetic fixation feature to affix the central rare earth magnet to the plunger rod portion through the hole in the central rare earth magnet.

In some embodiments of the intrusive pig detector, the trigger-plunger subassembly is maintained within the pipe nipple with an internal retaining ring.

In some embodiments of the intrusive pig detector, the debris wiper ring between the trigger portion and the nipple prevents pipeline debris from entering an interior space of the nipple.

Additional aspects and advantages of the present disclosure will become readily apparent to those skilled in this art from the following detailed description, wherein only exemplary embodiments of the present disclosure are shown and described, simply by way of illustration of the several modes or best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the device are set forth with particularity in the appended claims. A better understanding of the features and advantages of the present device will be obtained by reference to the following detailed description that sets forth illustrative embodiments, in which the principles of the device are utilized, and the accompanying drawings of which:

FIG. 1 is a front perspective view of an exemplary embodiment of the intrusive pipeline detector.

FIG. 2 is a front perspective view of the exemplary embodiment of the intrusive pipeline detector of FIG. 1 in an activated position.

FIG. 3 is a cross-section view of the exemplary embodiment of the intrusive pipeline detector of FIG. 2 at a point immediately after activation of the trigger-plunger assembly, but just before the release of the indicator cover.

FIG. 4A is a detail cross-section view of the exemplary embodiment of the intrusive pipeline detector of FIG. 3 illustrating exploded views of the central portion of the detector with a plurality of rare earth magnetically opposed dog magnets, disengaged from the stop nut.

FIG. 4B is a further detail cross-section view of the exemplary embodiment of the intrusive pipeline detector of FIG. 4A illustrating further exploded views of the central portion of the detector with a plurality of rare earth magnetically opposed dog magnets, disengaged from the stop nut, and additional close detail of the plunger rod portion, the central rare earth magnet and other internal features of the device.

FIG. 5 is a cross-section view of the exemplary embodiment of the intrusive pipeline detector representative of FIGS. 4A & 4B in the activated position illustrating the critical components of the device and their positions in the activated state immediately after activation and release of the indicator cover (6) into its activated position (6b) and immediately prior to the automatic return of the trigger-plunger assembly (4) caused by the second compression spring (10), to its ready state inside of the pipeline, after the mechanical pig or inspection device has passed.

FIG. 6 is a cross-section view of the exemplary embodiment of the intrusive pipeline detector of FIG. 5 in the activated position illustrating most of the critical components of the device and their positions in the activated state after initial activation, but following the passage of a mechanical pig or inspection device passed said location, when the trigger-plunger subassembly retracts and drops distally back into the pipeline. At this point, the rare earth magnetically opposed dog magnets once again move radially outward away from each other after the central rare earth magnet drops away.

FIG. 7 is a complete cross-section view of the exemplary embodiment of the intrusive pipeline detector of FIG. 3 in the activated position illustrating all of the critical components of the device and their positions in the activated state after initial activation.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

While preferred embodiments of the present disclosure have been shown and described herein, it will be obvious to those skilled in the art that such embodiments are provided by way of example only. Numerous variations, changes, and substitutions will now occur to those skilled in the art without departing from the device, in accordance with the claims. It should be understood that various alternatives to the embodiments of the device described herein may be employed in practicing the device.

The present device will now be described more fully hereinafter with reference to the accompanying drawings which illustrate embodiments of the Intrusive Detector for Passage of Mechanical Cleaning or Inspection Device in a Pipeline.

This device may, however, be embodied in many different forms and should not be construed as limited to the illustrated embodiments set forth herein. Rather, these embodiments are provided so that this disclosure will be thorough and complete, and will fully convey the scope of the device to those skilled in the art.

The following description of the exemplary embodiments refers to the accompanying drawings. The following detailed description does not limit the device. Instead, the scope of the device is defined by the appended claims

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment.” “in an embodiment,” or variations thereof in various places throughout the disclosure is not necessarily referring to the same embodiment Further, the particular features, structures of characteristics may be combined in any suitable manner in one or more embodiments.

As used herein, and unless otherwise specified, the term “pig”, “pipeline pig”, or “scraper” generally refers to cleaning and inspection gauges or gadgets, devices generally referred to as “pigs”, to perform various maintenance operations, such as mechanical cleaning and inspection in pipelines used for transporting liquids or gases, without stopping the flow of the product in the pipeline.

A pig is a tool sent down or “launched” in the pipeline and propelled by the pressure of the product flowing through the pipeline itself. There are typically four main uses for pigs: Physical separation between different fluids in the pipeline; Clearing slugs of liquid from multi-phase gas/liquid pipelines; Internal cleaning of pipelines; and Inspection of internal surfaces and joints of pipelines to assess their condition and to prevent leaks, which can be hazardous or harmful to the environment. They then exit the pipeline at a “pig receiver” where they can be inspected or replaced

In the oil and gas industry, a mechanical pig is one of the most common types of pipeline pigs and commonly refers to a tool used for pipeline maintenance, typically for cleaning, inspecting, or separating different fluids in pipelines.

There are a number of types of mechanical pigs.

These include:
1. Cleaning Pigs: Used to remove debris, scale, paraffin, or other deposits from the inside of pipelines. Examples include: brush pigs, scraper pigs, or foam pigs.
2. Sealing Pigs: Equipped with rubber or polyurethane cups/discs to create a tight seal; used for fluid separation, hydrostatic testing, and dewatering.
3. Batching Pigs: Which separate different types of products in multi-product pipelines and prevent contamination between different fluids. And finally;
4. Displacement Pigs: Which are used in hydrotesting or to push air, water, or another fluid from the pipeline.

In the specific areas of pipeline or tubing inspection; mechanical pigs can carry sensors or brushes to inspect tubing integrity and remove obstructions.

Alternatively, the industry also uses Smart Pigs (or intelligent pigs) with Data Logging sensors for pipeline inspection (e.g., corrosion detection, crack analysis). Advanced versions may include sensors for logging wellbore conditions as they travel through casing or tubing.

However, the term “mechanical pig” in a downhole context sometimes relates to wellbore intervention tools that assist in cleaning, retrieving debris, or performing mechanical operations inside the well.

Some common uses of mechanical pigs in downhole applications may include: 1. Wellbore Cleaning and Debris Removal: Mechanical pigs can be run in the wellbore to remove scale, paraffin, or other deposits that could restrict flow or interfere with operations. 2. Plug Setting or Removal: Some downhole pigs are designed to mechanically interact with plugs or packers, assisting in their setting or removal.

Although more common in surface pipelines, pigs can also be used in downhole applications to separate different fluids, such as displacing drilling mud with completion fluids.

A pig signaler in the pipeline industry (or pipeline operations) is a device used to detect, indicate, and confirm the passage of a pig (pipeline inspection gauge) through a specific point in a pipeline or wellbore.

It is typically mounted on the outer surface of a pipeline or wellhead and detects when a pig passes through. The signaler provides a visual, mechanical, or electronic signal to confirm the pig's location. Some pig signalers are equipped with pressure sensors, magnetic detectors, or mechanical flappers that move when the pig passes.

Types of pig signalers include:
1. Mechanical Signalers: A simple trigger or flag moves when the pig passes. No electricity is required. They are relatively common in rugged field environments.
2. Electronic Signalers: Use sensors or pressure switches to detect the pig. They can send remote alerts via SCADA or telemetry.
3. Magnetic Signalers: Detect pigs equipped with magnets. They are non-intrusive, no need to penetrate the pipeline.
4. Ultrasonic or Acoustic Signalers: Use sound waves to detect the pig's movement. They are ideal for non-metallic pipelines.

Pig Signalers are integral to confirmation of successful pigging operations (cleaning, batching, or inspection). They monitor pig location and tracking movement in long pipelines. And provide enhanced safety by ensuring pigs are accounted for before opening receivers. They provide automation & remote monitoring for digital oilfield and pipeline integrity management. And finally, provide for pipeline integrity by ensuring cleaning or inspection tools reach their intended locations, especially in automation & remote monitoring in digital oilfield setups.

Pig signalers are also sometimes classified as Intrusive and Non-intrusive pig signalers. An intrusive pig signaler is installed inside or projecting into the pipeline and physically interacts with the pig as it passes through the pipeline. The intrusive pig signaler can be a mechanical switch, magnet, or sensor that triggers a signal when the pig comes into contact with it. The intrusive pig signaler may require a special fitting to be installed in the pipeline to allow for its insertion and removal. A non-intrusive pig signaler, on the other hand, does not physically interact with the pig as it passes through the pipeline Instead, it uses an external sensor or detector to detect the passage of the pig through the pipeline. This can be done using a variety of methods, including ultrasonic sensors, radio frequency identification (RFID) tags, or acoustic detectors. The choice between intrusive and non-intrusive pig signalers depends on various factors, including the type of pig being used, the size and material of the pipeline, and the operating conditions. Non-intrusive pig signalers are typically easier to install and maintain but may not be as accurate or reliable as intrusive pig signalers. Intrusive pig signalers, on the other hand, provide more accurate and reliable detection but require more complex installation procedures and may have a greater risk of damage to the pipeline.

This type of pig signaler is commonly also referred to as a magnetic intrusive pig signal. An example of this type of signaler is described in U.S. Pat. No. 7,861,665 to Rankin, the content of which is hereby incorporated by reference.

Another example of this type of signaler is described in U.S. Pat. Nos. 9,248,477 and 9,551,450 to Klemm, et al, the content of which is hereby incorporated by reference.

A magnetic intrusive pig signal typically includes a plug assembly and nipple combination, or a plug assembly and flange combination, that places the nipple in fluid communication with the interior of the pipeline. An O-ring or other equivalent sealing means is used to contain the pipeline pressure. Located within a cavity of the plug assembly is a trigger mechanism having polar opposite magnets. The trigger mechanism is in communication with the release mechanism of an indicator assembly that includes a flag or other device that indicates the passage of a pipeline pig. As a pipeline pig moves along the interior of the pipeline and past the magnetic intrusive pig signal, the pig urges against the trigger. This causes the lower magnet of the trigger mechanism to travel upward toward the upper magnet. As the upper magnet is repelled by the lower magnet, its mounting shaft urges against a release mechanism which activates the flag of the indicator assembly.

Although magnetic intrusive pig signals provide a number of advantages, this type of signal can be negatively affected from time-to-time by ferromagnetic debris such as metal flakes which are attracted to the lower repulsive magnet of the trigger mechanism. The debris can cause the trigger mechanism to jam because of the close fit and tolerances within the trigger cavity. Additionally, heavy waxy sludge sometimes enters the cavity and causes the trigger mechanism to jam. This can be particularly troublesome in the magnet area of the trigger cavity.

However, in all three cases, the design presented herein is actually much simpler and more elegant in design than those of Rankin and Klemm. Specifically, in the case of Klemm, the design utilizes either a rubber boot, Teflon (or equivalent material) seals and/or sliding filter packs to filter out or prevent the ferromagnetic debris and sludge for fouling the mechanism, while never addressing the constant pipeline pressures that forces those materials into the device. Whereas in the present case, a pressure canal is utilized in conjunction with pressure equalization ports and a unique non-magnetic fixation feature of the central rare earth magnet to neutralize the forces acting on the trigger-plunger subassembly due to internal pipeline pressure before it can force those ferromagnetic debris and sludge for fouling the mechanism.

As used herein, and unless otherwise specified, the terms “Intrusive Detector”, “Intrusive Pig Detector”, “Pig Signaler” or like terms refers to a device used in the oil and gas industry to detect the passage of a pipeline cleaning or inspection gauge, or “pig.” The pig signaler is typically installed at a point along the pipeline where the pig is expected to pass, such as at the receiving end of a pipeline or at a valve station. The signaler detects the passage of the pig and sends a signal to the control room, indicating that the pig has passed and providing information on its location and speed. The information provided by the pig signaler is important for pipeline operators to monitor the condition of the pipeline and to detect any issues such as corrosion, cracks, or other damage that may require maintenance or repair. Regular inspection and maintenance of pipelines using pigs and pig signalers can help ensure the safe and efficient transportation of oil and gas.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 5.0 kg, 2.5 kg, 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “about” or “approximately” means within 1 hour, within 45 minutes, within 30 minutes, within 25 minutes, within 20 minutes, within 15 minutes, within 10 minutes, within 5 minutes, within 4 minutes, within 3 minutes, within 2 minutes, or within 1 minute. In certain embodiments, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degree, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “substantially”, or “substantially equal” means within 1 or 2 standard deviations. In certain embodiments, the term “substantially”, or “substantially equal” means within 5%, 4%, 3%, 2%, 1%, 0.5%, 0.1%, or 0.05% of a given value or range. In certain embodiments, the term “substantially”, or “substantially equal” means within 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “substantially”, or “substantially equal” means within 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “substantially”, or “substantially equal” means within 2 minutes, or within 1 minute. In certain embodiments, the term “substantially”, or “substantially equal” means within 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “plurality”, and like terms, refers to a number (of things) comprising “two or more” (things), “three or more” (things), “four or more” (things), “five or more” (things), etc.

As used herein, the terms “connected”, “operationally connected”, “coupled”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

As used herein, the terms “comprises”, “comprising”, or any other variation thereof, are intended to cover a nonexclusive inclusion, such that a process, method, article, or apparatus that comprises a list of elements does not include only those elements but may include other elements not expressly listed or inherent to such process, method, article, or apparatus.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, and unless otherwise specified, the term “anterior” can refer to the front surface of a body or thing; or often used to indicate the position of one structure relative to another, that is, situated nearer the front part of a body or thing. Alternately, it may also refer in a similar fashion to an apparatus or structure.

As used herein, and unless otherwise specified, the term “posterior” can refer to the back surface of a body or thing; Or, often used to indicate the position of one structure relative to another, that is, nearer the back of the body or thing. Alternately, it may also refer in a similar fashion to an apparatus or structure.

As used herein, and unless otherwise specified, the term “superior” can refer to something situated nearer the vertex of a thing in relation to a specific reference point; opposite of inferior. Or, often used to indicate the position of one structure relative to another, that is, it may also mean situated above or directed upward. Alternately, it may also refer in a similar fashion to an apparatus or structure.

As used herein, and unless otherwise specified, the term “inferior” can refer to a thing situated below or nearer the bottom in relation to a specific reference point; opposite of superior. Or, often used to indicate the position of one structure relative to another, that is, it may also mean situated below or directed downward. Alternately, it may also refer in a similar fashion to an apparatus or structure.

As used herein, and unless otherwise specified, the term “medial” can refer to a thing situated toward the median plane or midline of a body. Alternately, it may also refer in a similar fashion to an apparatus or structure.

As used herein, and unless otherwise specified, the term “lateral” can refer to denoting a position farther from the median plane or midline of a body or a structure. It may also mean “pertaining to a side”. Alternately, it may also refer in a similar fashion to an apparatus or structure.

As used herein, the term “proximity” means nearness in space or relationship, but not excluding the potential to be touching. Proximity is also alternatively meant to mean that one thing may be so close to another thing as to be “in direct or nearly direct contact” (in proximity) with another thing along some point. To “place something in proximity” is also meant to mean that items may be “paired” or “mated together” either in their paired function or at some point of contact.

As used herein, and unless otherwise specified, the term “vertically oriented” and similar terms mean; generally perpendicular to, at, or near, right angles to a horizontal plane; in a direction or having an alignment such that the top of a thing is above the bottom. In certain embodiments, the term “vertically oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range from right angles to a horizontal plane, including increments therein.

As used herein, and unless otherwise specified, the term “horizontally oriented” and similar terms mean; generally perpendicular to, at, or near, right angles to a vertical plane; in a direction or having an alignment such that the top of a thing is generally on, or near the same plane as the bottom, both being parallel or near parallel to the horizon. In certain embodiments, the term “horizontally oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range from right angles to a vertical plane, including increments therein.

As used herein, and unless otherwise specified, the term “substantially perpendicular” and similar terms mean generally at or near 90 degrees to a given line, or surface or to the ground. In certain embodiments, the term “substantially perpendicular” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, the term “precision threads” means a thread form having an imperial fine thread series, (UNF/UNRF/UNEF), or metric fine or extra fine thread series (M size×pitch) commonly used in precision applications. It may also be defined as any fine or very fine pitch thread. Because of the larger tensile stress areas, they have high tension strength Precision threads, as used herein, also comprise extra fine and superfine threads, with very fine pitch threads because they have greater minor diameters than course threads, have a greater cross-sectional area (and therefore greater load-carrying capability) for the same nominal diameter; and they are more resistant to coming loose from vibration. Other examples of fine and very fine thread pitches include: AJS Series patented threads, Löwenherz thread, (a largely obsolete metric thread form); and the Thury metric screw thread (alternatively called the Filière Suisse, FS, screw thread).

As used herein, and unless otherwise specified, the term “NPT” or “National Pipe Thread” means or refers to an American standard defined in ASME B1-20.1, and is the most popular series, being a tapered pipe thread. However, other pipe thread series are also well known and include NPTSC/NPSC (National Pipe Internal Straight Threads for Couplings), NPTR (National Pipe Threads for Railing Joints), NPSM (Straight Pipe Threads for Mechanical Joints) and NPSL (Loose-Fitting Mechanical Joints w/Locknuts).

As used herein, and unless otherwise specified, ccombinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

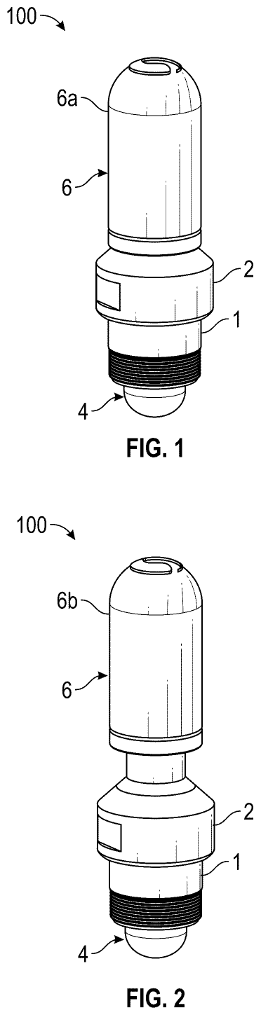

Referring now to FIG. 1, a front perspective view of an exemplary embodiment of the intrusive pipeline detector. The intrusive detector (100) is portrayed in a “ready state”, as though it were mounted in a pipeline in a vertically oriented position, essentially perpendicular to the subject pipeline. The exemplary embodiment comprises a threaded thick-wall steel seamless pipe nipple (1), commonly comprising an appropriate “NPT” or “National Pipe Thread” and is the most popular series, being a tapered pipe thread. However, other pipe thread series may also be utilized depending on the material and or country where the device is employed. Alternately, the inferior connecting portion of the pipe nipple may also employ a collar for welded attachment to the subject pipeline, while also having a threaded superior portion for attachment to the intrusive pipeline detector collar (2). As described herein, the “ready state” refers to the condition of the intrusive pipeline detector (100) wherein it is primed for detection of a passing mechanical pig or inspection device beyond it's current location in the pipeline. This means that the trigger-plunger subassembly (4) is fully inserted within the pipeline (within it's range of travel in the device 100 and has not yet been engaged or activated by the passing of a mechanical pig or inspection device. This is apparent by the fact that the indicator cover (6) of the device is still in it's “down” or “ready state” position, referred to herein as position (6a).

Referring now to FIG. 2, a front perspective view of the exemplary embodiment of the intrusive pipeline detector (100) of FIG. 1 in an “activated state”. The same device as described above in FIG. 1 is now illustrated as it would appear after a mechanical pig or inspection device had passed the detection device, thus pushing the trigger-plunger subassembly (4) superiorly into the body of the device, pushing the trigger portion (4.1a). the plunger rod portion (4.1b) and the central rare earth magnet (4.2) proximally against the force of the second compression spring (10), up to the location of the plurality of rare earth magnetically opposed dog magnets inside of the collar housing (2) that prevent the stop nut (5) from moving Once the central rare earth magnet (4,2) attains the level of the plurality of rare earth magnetically opposed dog magnets (7) in the collar housing (2), the dogs (7) are drawn toward the center of the device by the attractive magnetic force of the central rare earth magnet (4.2), thus releasing the stop nut (5). This in turn allows the restrained first compression spring (9) to release its compressed load and lift the indicator cover (6) to its maximum travel height, or the activated position, referred to herein as position (6b). In some embodiments, the second compression spring (10) is a conical compression spring configured for confined spaces.

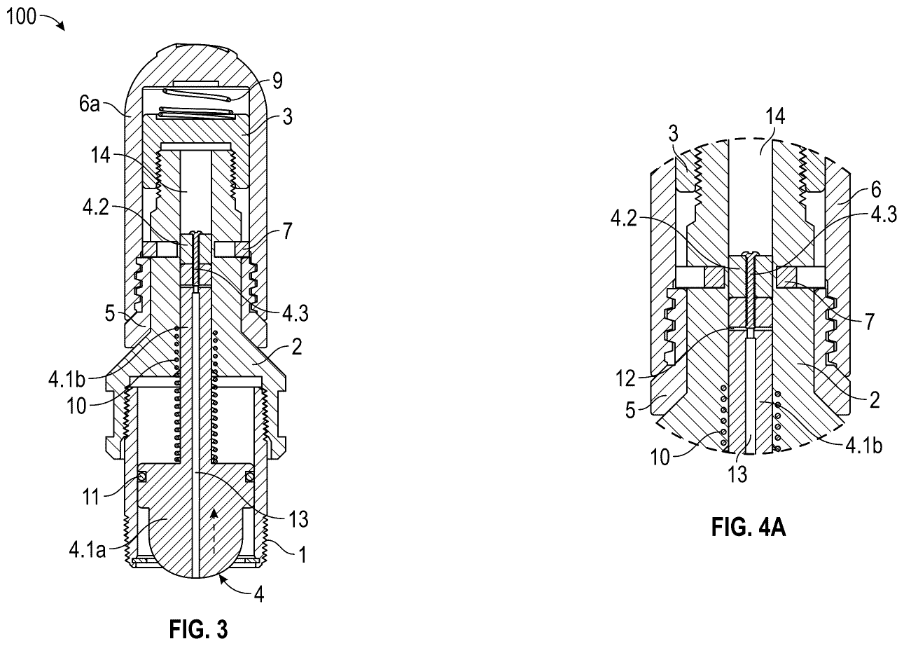

As more clearly illustrated in the following figures, FIG. 3 is a cross-section view of the exemplary embodiment of the intrusive pipeline detector (100) of FIG. 2 at a point immediately after activation of the trigger-plunger assembly (4), but just before the release of the indicator cover (6). As described previously; as a mechanical pig or inspection device passes the detection device, the trigger-plunger subassembly (4) is pushed superiorly into the body of the device, pushing the trigger portion (4.1a), the plunger rod portion (4.1b) and the central rare earth magnet (4.2) proximally within a hollow shaft (14) in the center of the collar housing (2), against the force of the second compression spring (10), up to the location of the plurality of rare earth magnetically opposed dog magnets that prevent the stop nut (5) from moving. This is the instant condition being demonstrated herein.

Also illustrated herein in FIG. 3, 4A & 4B (and others) are a central thru-port pressure canal (13) and pressure equalizing ports (12) neutralize the forces acting on the trigger-plunger subassembly (4) due to internal pipeline pressure. These features address deficiencies found in the existing art which commonly utilizes a spring to hold a triggering mechanism downward when subjected to the internal pressure of the pipeline when installed. The force of the spring is directly dictated by the pressure in the pipeline. Thus, a range of springs are used depending on the anticipated pressure range of the pipeline. A problem with the existing art is that the pipe pressure variances require trial and error to determine proper spring sizing. Whereas in the current design presented herein, the pipeline pressure is relieved thru the central thru-port pressure canal (13) and pressure equalizing ports (12) and only one simple compression spring (10) with a known size and force is needed to hold the trigger-plunger subassembly (4) downward in the pipeline. Further still, the pressure canal (13) is utilized in conjunction with the pressure equalization ports (12) and a unique non-magnetic fixation feature (4.3) used to operably couple the central rare earth magnet to the plunger rod portion (4.1b) to neutralize the forces acting on the trigger-plunger subassembly due to internal pipeline pressure before the pipeline pressure can force those ferromagnetic debris and sludge for fouling the mechanism. Further still, the fixation feature may be configurable to allow the pressure to be released either around or through the fixation feature without allowing any ferromagnetic debris or sludge to pass.

Further, as described previously, the plurality of rare earth magnetically opposed dog magnets (7), in combination with the central rare earth magnet (4.2) having an opposite polarity to the dogs magnets (7), addresses another key problem with the existing art. As noted earlier, existing art utilizes mechanical dog latches or catch fingers which are pivotal towards and away from the central axis of the housing and which are provided with catches. A trigger connects with an actuator which is positioned to bear against the sides of the catch fingers to cause them to pivot outwardly away from each other when the actuator moves up vertically The catch fingers are provided with a garter spring to urge them radially inwardly towards the central axis. When a pig or inspection device moves in the pipeline past the trigger and actuates the trigger, the actuator will bear against the fingers and separate them radially against the action of the garter spring to release the lock pin to allow the indicator to move upwardly within the indicator housing so as to provide a visual indication that a pig or inspection device has passed. These mechanical dog latches or catch fingers are prone to wear and failure resulting in timely and costly maintenance. In contrast, the design described herein does not need to deal with garter springs which are prone to breakage, and the rare earth magnets are the strongest type of permanent magnets made, producing significantly stronger magnetic fields than other types such as ferrite or alnico magnets. And finally, rare-earth magnets, particularly neodymium magnets, are highly resistant to wear due to their protective surface treatments like nickel plating, which provides robust corrosion protection. This makes them durable and suitable for various applications requiring strong, compact permanent magnets.

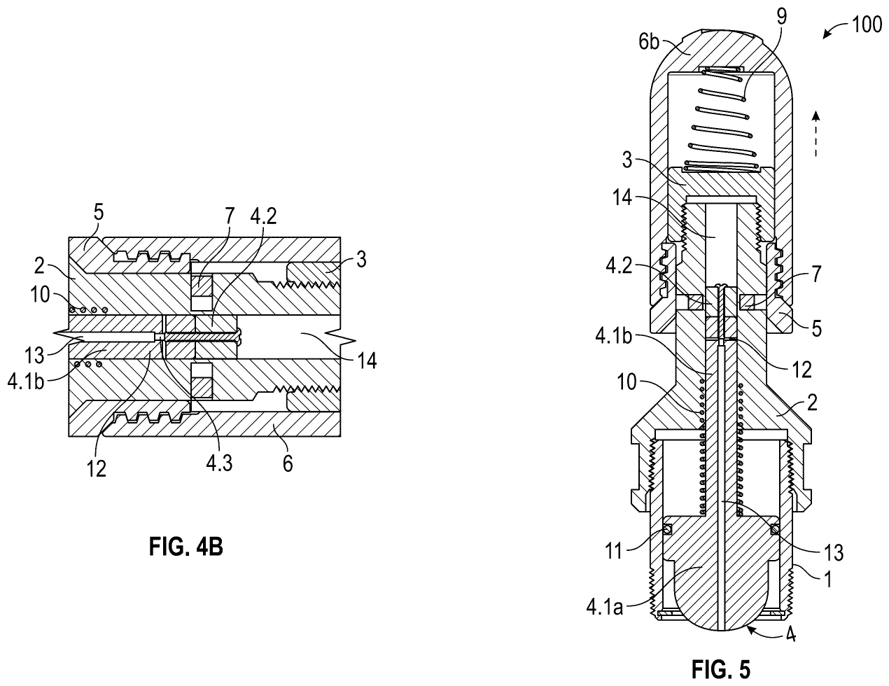

Referring next to FIGS. 4A and 4B are detailed cross-section views of the exemplary embodiment of the intrusive pipeline detector of FIG. 3, immediately following the activation of the plurality of rare earth magnetically opposed dog magnets (7) by the polarity of the central rare earth magnet (4.2). The detail exploded views illustrate the central portion of the detector (100), at the moment the trigger portion (4.1a) and plunger rod portion (4.1b) that penetrates a hollow shaft (14) and carries the central rare earth magnet (4.2), attains the same vertical level as that of the plurality of rare earth magnetically opposed dog magnets (7) within the hollow shaft (14) in the center of the collar housing (2). At this point, the polarity of the central rare earth magnet (4.2) attracts the plurality of dogs (7) which are now drawn toward the center of the collar housing (2) by the attractive magnetic force of the central rare earth magnet (4.2), (counter-acting the magnetic opposed polarity of the dog magnets), pulling the dogs (7) away (disengaging) from the top of the stop nut (5), thus releasing the stop nut (5). This in turn allows the restrained confined space conical compression spring (9) sitting atop a cap (3) operationally coupled to the top of the collar housing (2), to release its compressed load energy and lift the indicator cover (6) to its maximum travel height or the activated position (6b), as further illustrated in FIGS. 2 & 5.

Referring now the FIG. 5, is the full cross-section view of the exemplary embodiment of the intrusive pipeline detector representative of FIGS. 4A & 4B in the activated position illustrating most of the critical components of the device and their positions in the activated state immediately after activation.

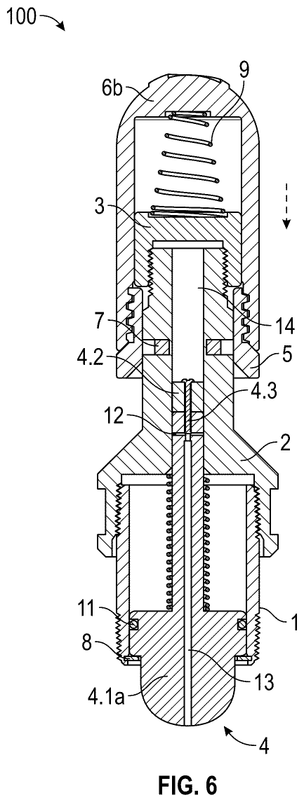

Referring next to FIG. 6, is a cross-section view of the exemplary embodiment of the intrusive pipeline detector of FIG. 5 in the activated position illustrating most of the critical components of the device and their positions in the activated state after initial activation, but now following the complete passage of the mechanical pig or inspection device past said location, when the trigger-plunger subassembly (4) retracts and drops the trigger portion (4.1a), distally back into the pipeline, and the rare earth magnetically opposed dog magnets (7) once again move radially outward away from each other after the central rare earth magnet (4.2) drops away. The retraction of the central rare earth magnet (4.2) can be assured by the presence of a non-magnetic fixation feature (4.3) to operably couple the central rare earth magnet (4.2) to the plunger rod portion (4.1b) through the hole in the central rare earth magnet. For illustrative purposes, an 18-8 (non-magnetic, not cold-worked or hardened) stainless steel button head hex drive screw is shown to accomplish this purpose.

However, one skilled in the art would recognize and appreciate that the non-magnetic fixation feature (4.3) could be configured from a plurality of cost effective materials including aluminum, copper, tin, zinc and alloys such as brass. Other suitable non-magnetic alternatives may include some plastics since the function of the fixation feature (4.3) would carry minimal load. Further, one of skill in the art would recognize and appreciate that the fixation feature (4.3) need not be a screw or bolt. Rather, by way of limited examples, it could be a compression fitting, a press-fit plug, or a bayonet-type of fitting, to name but a few.

Further still, of skill in the art would recognize and appreciate that the “thru-hole” previously described in the central rare earth magnet could be threaded or non-threaded or have other types of internal features for accepting the aforementioned fixation feature (4.3).

Also illustrated herein are two other critical features of the design. The first feature is an internal retaining ring (8) positioned on the interior of the thick-walled stainless steel pipe nipple (1), near the distal end. This internal retaining ring (8) serves the purpose of limiting the distal travel of the trigger portion (4.1a) of the trigger-plunger subassembly (4) to a known depth of penetration within the pipeline. The second feature illustrated herein is a debris wiper (11) positioned on the major diameter of the trigger portion (4.1a) and which is in continuous contact with the (polished) internal diameter of the thick-walled stainless steel pipe nipple (1). The debris wiper (11) serves the purpose of creating a seal and preventing sludge, wear particles and ferromagnetic debris from fouling the sliding action of the trigger-plunger subassembly (4) and other internal components of the device.

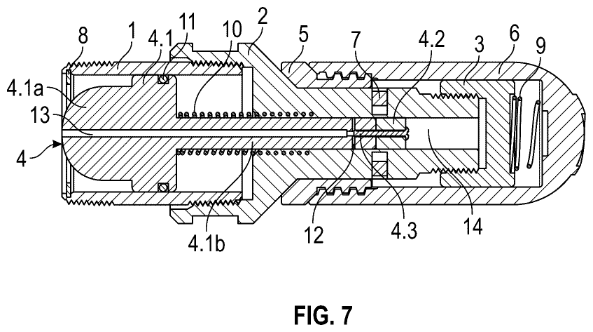

Finally, FIG. 7 is a complete engineering cross-section view of the exemplary embodiment of the intrusive pipeline detector of FIG. 3 illustrating and labeling all of the critical components of the device and their positions at a point immediately after activation of the trigger-plunger assembly, but just before the release of the indicator cover.

While preferred embodiments of the present device have been shown and described herein with a certain degree of particularity, it will be obvious to those skilled in the art that such embodiments are provided by way of example only. Numerous variations, changes, and substitutions will now occur to those skilled in the art without departing from the device. It should be understood that various alternatives to the embodiments of the device described herein may be employed in practicing the device without departing from the spirit and scope of this disclosure. It is intended that the following claims define the scope of the device and that methods and structures within the scope of these claims and their equivalents be covered thereby.

What is claimed is:

1. A device for indicating the passage of a mechanical pig or inspection device beyond a predetermined location in a pipeline comprising:
an intrusive detector (100) for connecting to a pipeline and communicating with the interior of the pipeline through an opening at said location;
a trigger-plunger subassembly (4) slidably mounted in the detector (100) and adapted to project downwardly into the interior of the pipeline through said opening having a central thru-port pressure canal (13) and pressure equalizing ports (12) to neutralize the forces acting on the trigger-plunger subassembly (4) due to internal pipeline pressure;
a pipe nipple (1) which can be connected to and protrude from the outside of a pipe in any conventional manner and adapted to contain and support the trigger-plunger subassembly (4);
a collar housing (2) releasably connectable to the protruding pipe nipple (1);
a stop nut (5) slidably affixed to the collar housing (2);
a cap (3) affixed to the collar housing (2) configured to establish a maximum limit travel of the stop nut (5);
an indicator cover (6) removably affixed to the stop nut (5) configured to slide over the cap (3);
a first-compression spring (9) positioned between the indicator cover and the cap (3):
a second compression spring (10) configured to push the trigger-plunger subassembly (4) into the interior of the pipeline through said opening and within the pipe nipple (1);
a plurality of rare earth magnetically opposed dog magnets (7) slidably positioned within an equivalent plurality of spaces provided in the collar housing (2);
wherein said plurality of rare earth magnetically opposed dog magnets (7) remain positioned between the major diameter of the collar housing (5) and the inside diameter of the indicator cover (6) to prevent the stop nut (5) and indicator cover (6) from moving superiorly due to the force applied by the first compression spring (9).

2. The trigger-plunger subassembly (4) of claim 1, further comprising:
a plunger (4.1) comprising a trigger portion (4.1a) that penetrates the pipeline and a plunger rod portion (4.1b) that penetrates a hollow shaft (14) in the collar housing (2);
a central rare earth magnet (4.2) with a hole therethrough and
the second compression spring (10) positioned between the proximal end of the trigger portion (4.1a) and a shoulder at the base of the hollow shaft (14) in the collar housing (2).

3. The plurality of rare earth magnetically opposed dog magnets (7) of claim 1 comprising:
Neodymium (Nd—Fe—B); or
Samarium Cobalt (SmCo).

4. The central rare earth magnet (4.2) of claim 2 comprising:
Neodymium (Nd—Fe—B); or
Samarium Cobalt (SmCo).

5. The intrusive detector (100) of claim 1, wherein the hollow shaft (14) in the collar housing (2) has a longitudinal geometric profile that is:
cylindrical; or
triangular; or
oval-shaped; or
“x-” or cross-shaped; or
pentagonal; or
hexagonal; or
octagonal; or
corresponds with having a plurality of sides equal in number to the plurality of rare earth magnetically opposed dog magnets slidably positioned within spaces provided in the collar housing.

6. The intrusive detector (100) of claim 1, wherein the central rare earth magnet (4.2) of claim 2 has a longitudinal geometric profile that is:
cylindrical; or
triangular; or
square; or
oval-shaped; or
“x-” or cross-shaped; or
pentagonal; or
hexagonal; or
octagonal; or
corresponds with having a plurality of sides equal in number to the plurality of rare earth magnetically opposing dog magnets slidably positioned within spaces provided in the collar housing.

7. The intrusive detector (100) of claim 1, wherein the plurality of rare earth magnetically opposed dog magnets (7) comprise:
2 dog magnets (7); or
3 dog magnets (7); or
4 dog magnets (7); or
5 dog magnets (7): or
6 dog magnets (7); or
7 dog magnets (7); or
8 dog magnets (7); or
more than 8 dog magnets (7).

8. The intrusive detector of claim 1 further comprising a debris wiper ring (11) between the plunger (4.1) and the nipple (1).

9. The intrusive detector of claim 1, wherein the plunger sub-assembly central thru-port pressure canal (13) in the trigger portion (4.1a) of the plunger (4.1) connects to at least one pressure equalization port (12) in the proximal plunger rod portion (4.1b).

10. The nipple (1) and collar housing (2) of claim 1, further comprising metal-to-metal sealing tapered threads.

11. The intrusive detector (100) of claim 1, wherein the plurality of rare earth magnetically opposed dog magnets (7) prevent the stop nut (5) from sliding proximally until a mechanical pig or cleaning device activates the plunger subassembly (4) pushing the trigger portion (4.1a), the plunger rod portion (4.1b) and the central rare earth magnet (4.2) proximally against the force of the second compression spring (10), up to the location of the plurality of rare earth magnetically opposed dog magnets (7), attracting said opposing dog magnets (7), causing them to slidably retract internally within the collar housing (2), away from the major diameter of the collar housing (5) and the inside diameter of the indicator cover (6), towards the central rare earth magnet (4.2).

12. The intrusive detector (100) of claim 1, wherein the first compression spring (9) forces the stop nut (5) and indicator cover (6) to slidably move proximally until engaging the cap (3) to provide a visual indication that a mechanical pig or inspection device has passed said location.

13. The trigger-plunger subassembly (4) of claim 2, wherein the second compression spring (10) is configured to push the trigger-plunger subassembly (4) distally back into the pipeline once the mechanical pig or cleaning device has completely passed the location.

14. The trigger-plunger subassembly (4) of claim 1, further comprising a non-magnetic fixation feature (4.3) to affix the central rare earth magnet (4.2) to the plunger rod portion (4.1b) through the hole in the central rare earth magnet.

15. The intrusive detector (100) of claim 1, wherein the trigger plunger subassembly (4) is maintained within the pipe nipple (1) with an internal retaining ring (8).

16. The intrusive detector of claim 8, wherein the debris wiper ring (11) prevents pipeline debris from entering an interior space of the nipple (1).
